(19) United States
(12) Patent Application Publication
(10) Pub. No.: US 2007/0036950 A1
(43) Pub. Date: Feb. 15, 2007

(54) Dry transfer lettering with separable units

(75) Inventor: Gus Dovellos, Dyer, IN (US)

Correspondence Address: BRINKS HOFER GILSON & LIONE, P.O. BOX 10395, CHICAGO, IL, 60610, US

(73) Assignee: Royal Brush Manufacturing, Inc.

(21) Appl. No.: 11/205,235

(22) Filed: Aug. 15, 2005

(51) Int. Cl. B41M 5/00

(52) U.S. Cl. 428/195.1

(57) ABSTRACT

A carrier sheet with completely or partially detachable perforated sheet units improves the transferability of dry transfer symbols. A carrier sheet of dry transfer symbols may be comprised of a plurality of dry transfer symbols removably affixed to a plurality of perforated sheet units. At least one dry transfer symbol may be removably affixed to at least one side of the plurality of perforated sheet units

### BACKGROUND OF THE INVENTION

1. Techical Field

The invention relates to transfer symbol applications. In particular, this invention relates to carrier sheets carrying dry transfer symbols.

2. Related Art

Dry transfer carrier sheets (“carrier sheets”) typically carry underlaid symbols transferable to a receiving surface. These symbols are commonly referred to as dry transfer symbols because they may be transferred without the use of any liquid. Such carrier sheets may include dry transfer symbols that are letters, numerals, punctuation marks, drawings, shapes, words, phrases, and the like. These carrier sheets are produced in various sheet sizes. Carrier sheet sizes may include 3¼″×5″ or 8¼″×11¼″. Often, carrier sheets include multiple underlaid dry transfer symbols with little spacing between each dry transfer symbol. Any desired underlaid dry transfer symbol on the carrier sheet may be readily transferred to a receiving surface simply by holding the carrier sheet against the receiving surface in a desired position and rubbing over the dry transfer symbol on the carrier sheet.

One problem with existing carrier sheets is that when holding the carrier sheet in place during the transfer of a desired dry transfer symbol, the user's hands often press on other dry transfer symbols elsewhere on the carrier sheet, thereby also transferring other symbols to the receiving surface. Another problem is damage to unused dry transfer symbols during manipulation of the carrier sheet. As users manipulate the carrier sheets, there is a tendency to wrinkle the sheets, thereby damaging or destroying some of the unused dry transfer symbols. Further problems exist when a user attempts to transfer dry transfer symbols removably affixed to larger carrier sheets. It is often difficult to manipulate these larger carrier sheets against receiving surfaces located in confined spaces (such as the pages of a bound book or the inside of a box) or that are awkwardly shaped (such as on model airplanes, cars, or boats).

Therefore, a need exists for a carrier sheet that will simplify the process of transferring dry transfer symbols while reducing the possibility of damaging or inadvertently transferring unused dry transfer symbols.

### SUMMARY

A carrier sheet with completely or partially detachable perforated units improves the transferability of dry transfer symbols. A carrier sheet of dry transfer symbols may comprise a plurality of dry transfer symbols removably affixed to a plurality of perforated sheet units. At least one dry transfer symbol may be removably affixed to at least one side of each one of the plurality of perforated sheet units.

Alternatively, a carrier sheet of dry transfer symbols may comprise a plurality of sheets linked together by at least one perforated edge. At least one dry transfer symbol may be removably affixed to at least one side of each one of the plurality of sheets.

Alternatively, a book of dry transfer carrier sheets may comprise a front cover, a rear cover affixed to the front cover, and a plurality of dry transfer carrier sheets further comprising a plurality of dry transfer symbols removably affixed to a plurality of perforated sheet units. The dry transfer carrier sheets are disposed between the front and rear cover. Additionally, separator sheets may be disposed between each of the plurality of carrier sheets. At least one dry transfer symbol is removably affixed to at least one side of each of the plurality of perforated sheet units on each carrier sheet.

Additionally, a method of applying dry transfer symbols may comprise the steps of: providing a carrier sheet of dry transfer symbols, the dry transfer symbols removably affixed to a plurality of perforated sheet units of the carrier sheet; separating a first of at least one of the perforated sheet units from the carrier sheet along at least one of a perforated edge; and applying the dry transfer symbol from the first perforated sheet unit to a receiving surface.

Other systems, methods, features and advantages of the invention will be, or will become apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

FIG. 1 is an elevation of a dry transfer carrier sheet with a plurality of perforated sheet units.

FIG. 2 is an elevation of a dry transfer carrier sheet with one of a plurality of perforated sheet units detached from the carrier sheet.

FIG. 3 is an elevation of multiple perforated sheets units, previously detached from a carrier sheet, configured to spell a desired word.

FIG. 4 is an elevation of an alternate dry transfer carrier sheet wherein the perforated sheet units are a mixture of at least two different shapes.

FIG. 5 is a perspective of a book of a plurality of dry carrier transfer sheets.

FIG. 6 is a flow diagram for transferring dry transferring lettering with separable sheet units.

FIG. 7 is an elevation of an alternate dry transfer carrier sheet of FIG. 4.

### DETAILED DESCRIPTION OF THE PREFERRED EMBODIMENTS

Dry transfer carrier sheets may be formed with perforated lines that permit a user to tear off an exact dry transfer symbol the user wants to apply. Dry transfer carrier sheets with sheet units separated by perforated lines simplifies the manner in which a user may separate a dry transfer symbol from a dry transfer carrier sheet. By separating the sheet units by perforated lines, the desired dry transfer symbol may be removed from the dry transfer sheet without inadvertently cropping or damaging adjacent dry transfer symbols. This increases the number of dry transfer symbols that may be used per dry transfer carrier sheet.

Additionally, the perforated lines eliminate the inefficient use of time. Now, a user no longer has to spend time manipulating a carrier sheet to separate a dry transfer symbol from the rest of the carrier sheet.

Furthermore, dry transfer carrier sheets with sheet units separated by perforated lines allows a user to apply dry transfer symbols to receiving surfaces that would not have been accessible with the full carrier sheet. These receiving surfaces may include the inside of a book cover, the inside of a box, or model airplanes, boats, cars, etc. Further, the problem of accidentally transferring extraneous dry transfer symbols may be avoided.

Dry transfer carrier sheets may be made from such material as translucent paper, cellulose acetate sheeting, cellulose acetate butyrate sheeting, vinyl polymer (polyvinyl chloride or polyvinyl acetate) sheeting, or cellophane. The carrier sheets may be opaque or translucent. FIG. 1 shows a carrier sheet 100 with a plurality of perforated sheet units 104. The carrier sheet 100 is comprised of a plurality of dry transfer symbols 102 removably affixed to a plurality of perforated sheet units 104 of the carrier sheet 100. Each one of the perforated sheet units 104 may be separated from the carrier sheet 100 by at least one perforated edge 112.

The perforated sheet units 104 may be formed in a variety of shapes. These shapes may include squares, rectangles, circles, triangles, trapezoids, other regular and irregular polygons, enclosed arced shapes, as well as other irregular enclosed shapes. For explanation and without limitation, the perforated sheet units 104 may be arranged in a grid. Alternatively, the carrier sheet 100 may comprise a combination of at least two differently shaped perforated sheet units 104 randomly spaced within the carrier sheet 100. Alternatively, the carrier sheet 100 may comprise a plurality of sheets that are linked together by at least one perforated edge.

Printed on a first side of each of the perforated sheet units 104 is at least one dry transfer symbol 102. The dry transfer symbol 102 may be an upper or lower case alphabetic character, numerical digit, punctuation mark, drawing, shape, word, phrase, or the like. Groups of these symbols 102 may be enclosed by the borders or one or more sheet units 104. The dry transfer symbol may be printed on the perforated sheet units 104 with a removably affixed opaque ink, as represented in U.S. Pat. No. 3,013,917. Alternatively, other methods of printing or adhering dry transfer symbols 102 may be used. Each dry transfer symbol 102 that is removably affixed to a perforated sheet unit 104 may be affixed such that when viewed through the second side of the perforated sheet unit 104 the dry transfer symbol 102 is in a normal reading position.

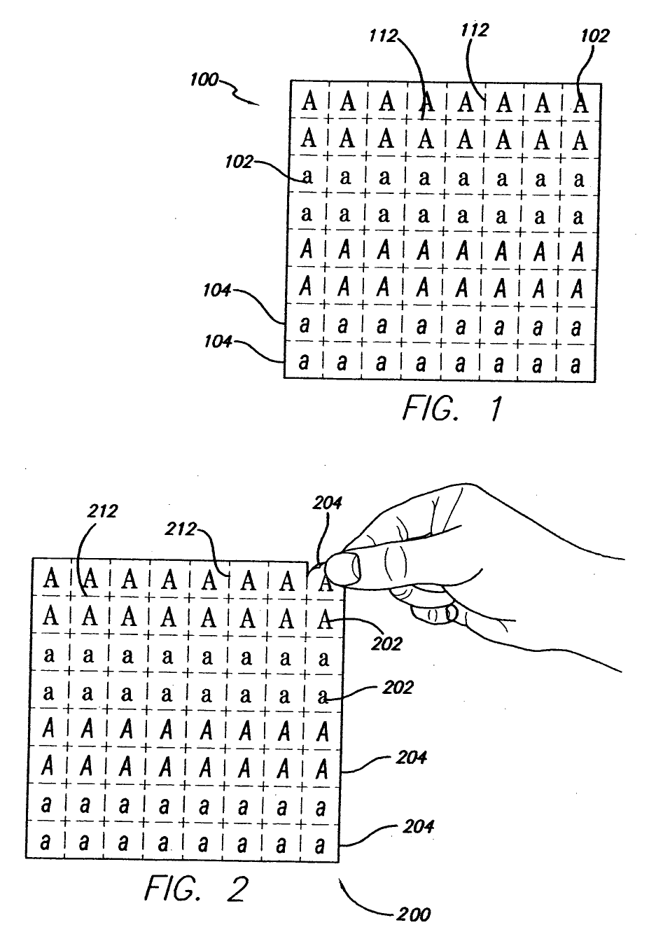

Dry transfer symbols 102 may be transferred to a receiving surface by placing the carrier sheet 100 on a receiving surface, with the dry transfer symbol 102 facing the receiving surface, and rubbing over the dry transfer symbol 102 on the exposed side of the carrier sheet 100. The receiving surface may be any surface capable of accepting a dry transfer ink as is known in the art. As shown in FIG. 2, at least one of the plurality of perforated sheet units 204 may be detached from the carrier sheet 200 by tearing out a perforated sheet unit 204 along its perforated edges 212. Once detached from the carrier sheet 200, this unit may be transferred to a receiving surface that may not have been accessible with the full carrier sheet (such as a book cover; the inside of a box; or on model airplanes, cars, or boats; etc.).

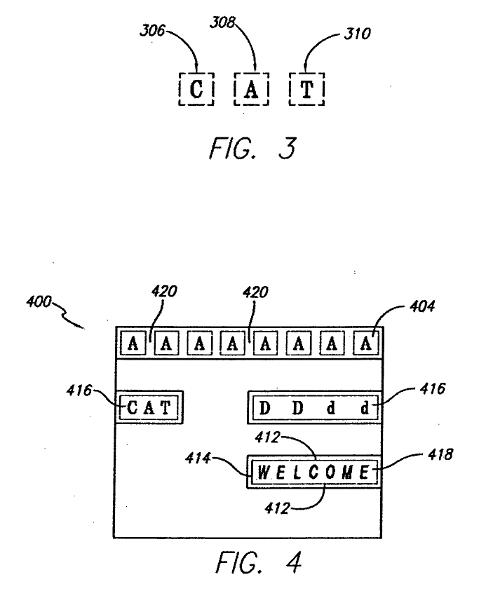

Additionally, multiple perforated sheet units may be detached from a carrier sheet, as illustrated in FIG. 3. Each of the multiple perforated sheet units may be removed one at a time until the desired perforated sheet units are detached from the carrier sheet. For explanation and without limitation, as illustrated in FIG. 3, removably affixed to a first detached perforated sheet unit 306 is a dry transfer symbol representing the letter “C.” Removably affixed to a second detached perforated sheet unit 308 is a dry transfer symbol representing the letter “A.” Removably affixed to a third detached perforated sheet unit 310 is a dry transfer symbol representing the letter “T.” These detached perforated sheet units may be laid out in a desired fashion (e.g to spell the word “CAT”), with each dry transfer symbol being transferred one at a time. Alternatively, after the individual perforated sheet units (306, 308, and 310) are detached from a carrier sheet, a word, pattern, phrase or the like may be formed and the perforated sheet units connected together through the use of a frame or adhesive prior to transferring the dry transfer symbols to a receiving surface.

An alternate configuration of the dry transfer carrier sheet is illustrated in FIG. 4. Carrier sheet 400 comprises a mixture of perforated sheet units. For explanation and without limitation, a portion of the perforated sheet units, 416 and 418, of carrier sheet 400 may be rectangular shaped while other perforated sheet units 404 may be square shaped. As illustrated in FIG. 4, it is possible to have multiple dry transfer symbols grouped together on one perforated sheet unit.

Perforated sheet unit 418 has two perforated edges 412 and one non-perforated edge 414. The dry transfer symbols removably affixed to perforated sheet unit 418 may be transferred to a receiving surface by detaching the two perforated edges 412 from the carrier sheet 400, lifting perforated sheet unit 418 up and away from the carrier sheet 400, placing the receiving surface under the perforated sheet unit 418, and then transferring the at least one dry transfer symbol to the receiving surface. Upon completion of the transfer, the perforated sheet unit 418 remains loosely attached to the carrier sheet 400.

Additionally, FIG. 4 illustrates perforated sheet units that are separated from each other by a non-detachable spacer area 420. In this configuration, perforated sheet units are circumscribed by perforations.

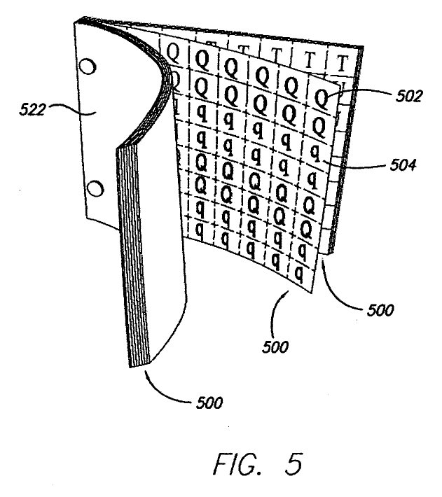

FIG. 5 illustrates a book of dry transfer carrier sheets. The book has a front cover 522 affixed to a rear cover. Disposed between the front cover 522 and rear cover are a plurality of dry transfer carrier sheets 500. Each of the plurality of dry transfer sheets is comprised of a group of perforated sheet units 504. Each of the plurality of perforated sheet units 504 has at least one dry transfer symbol 502 removably affixed to at least one side of the perforated sheet unit 504.

A user may flip through the plurality of carrier sheets 500 (e.g. the pages of the book) to locate a desired dry transfer symbol 502. Upon locating the desired dry transfer symbol 502, the user may separate the perforated sheet unit 504, containing the dry transfer symbol 502 from the carrier sheet 500 and transfer the dry transfer symbol 502 to a receiving surface. Separator sheets (not shown) may be interspersed between the carrier sheets to prevent the dry transfer symbols from being inadvertently transferred to adjacent carrier sheet or the rear cover.

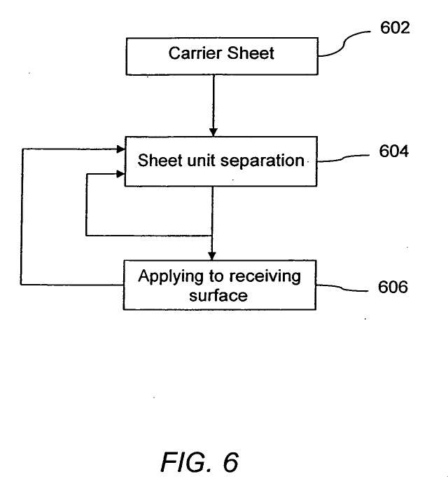

FIG. 6 is a flow diagram for transferring dry transferring lettering with separable sheet units. At act 602 a carrier sheet containing a plurality of perforated sheet units is provided. Of the perforated sheets units, some of them may contain removably affixed dry transfer symbols. The carrier sheet may be an individual carrier sheet or it may be one of a plurality of carrier sheets contained within a collection of carrier sheets. At act 604 a sheet unit may be separated from the carrier sheet. A user may separate a sheet unit by applying a force along at least one perforated edge. A user may grasp the carrier sheet in one hand while pulling a desired sheet unit away from the carrier sheet, along at least one of the perforations, with one or more fingers. Alternatively, a user may place the carrier sheet on a surface, and while holding the carrier sheet stationary, separate a sheet unit along at least one of the perforations. If a separator sheet is used, the separator sheet may have the same perforation pattern as the perforated sheet units. When a sheet unit is separated from the carrier sheet, a corresponding piece of the separator sheet, which is removably affixed to the sheet unit, may be removed from the separator sheet. The portioned of the separator sheet that is removed with the sheet unit is removed from the sheet unit prior to applying the dry transfer symbol to a receiving surface.

At act 606 a dry transfer symbol that is contained on a sheet unit separated from a carrier sheet may be applied to a receiving surface. The dry transfer symbol may be applied by placing the separated sheet unit on a receiving surface, with the dry transfer symbol facing the receiving surface, and rubbing over the dry transfer symbol on the exposed side of the sheet unit. Where a user desires to apply multiple dry transfer symbols acts 604 and 606 may be repeated until all of the desired dry transfer symbols have been applied to the receiving surface. Alternatively, a user may separate multiple sheet units prior to applying any of dry transfer symbols to a receiving surface. After all of the desired sheet units have been separated, the dry transfer symbols may then be applied to a receiving surface. Alternatively, any combination of separating sheet units and applying dry transfer symbols to a receiving surface may be followed.

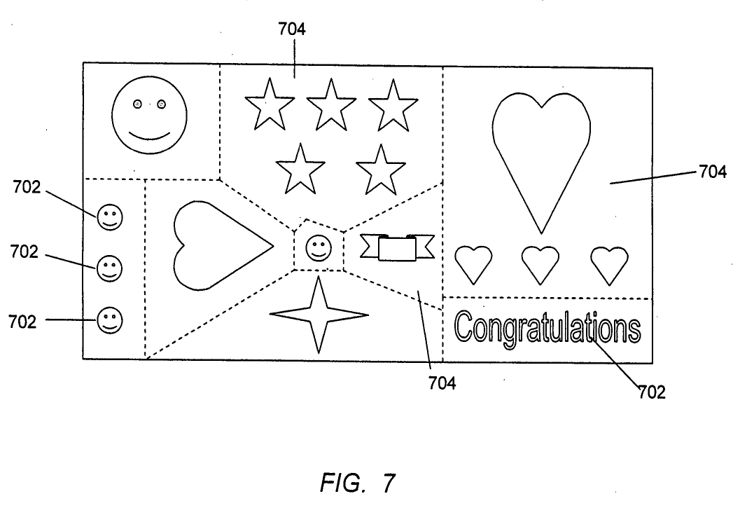

FIG. 7 is an elevation of an alternate dry transfer carrier sheet of FIG. 4. As shown, a dry transfer carrier sheet may be created with multiple differently shaped sheet units 704. Additionally, one or more dry transfer symbols 702 may be grouped together on one or more sheet units of the dry transfer carrier sheet 704.

It should be apparent, that other techniques may be used to create the carrier sheets. Besides a plurality of perforated sheet units, a carrier sheet may comprise a plurality of removable units that are removably affixed to an adhesive sheet. Each removable unit may be removed, as desired, in order to transfer its corresponding at least one dry transfer symbol.

From the forgoing descriptions it should be apparent that the above-described invention provides advantages over existing carrier sheets. Besides reducing the possibility of damaging or inadvertently transferring unused dry transfer symbols, the invention simplifies the process of transferring dry transfer symbols to confined spaces or awkward shaped receiving surfaces. Additionally, the invention provides a compact means of transporting the carrier sheets.

While various embodiments of the invention have been disclosed, it will be apparent to those of ordinary skill in the art that many more embodiments and implementations are possible within the scope of the invention. Accordingly, the invention is not to be restricted except in light of the attached claims and their equivalents.

I claim:

1. A carrier sheet of dry transfer symbols, said carrier sheet comprising:
a plurality of dry transfer symbols removably affixed to a plurality of perforated sheet units of said carrier sheet; and
at least one dry transfer symbol removably affixed to at least one side of each of said plurality of perforated sheet units.

2. The carrier sheet of claim 1, wherein a selected number of said perforated sheet units include at least one dry transfer symbol.

3. The carrier sheet of claim 1, wherein each of said plurality of perforated sheet units further comprise rectangles.

4. The carrier sheet of claim 1, wherein each of said plurality of perforated sheet units further comprise squares.

5. The carrier sheet of claim 1, wherein said plurality of perforated sheet units further comprise at least two different shapes.

6. The carrier sheet of claim 1, wherein said plurality of perforated sheet units are arranged in a grid.

7. The carrier sheet of claim 1, wherein a selected number of said plurality of perforated sheet units are separable from said carrier sheet by two perforated edges.

8. The carrier sheet of claim 1, wherein a selected number of said plurality of perforated sheet units are separable from said carrier sheet by three perforated edges.

9. The carrier sheet of claim 1, wherein a selected number of said plurality of perforated sheet units are completely separable from said carrier sheet.

10. The carrier sheet of claim 1, wherein a selected number of said plurality of perforated sheet units are separated by a non-detachable spacer area.

11. A carrier sheet of dry transfer symbols comprising:
a plurality of sheets linked together by at least one perforated edge; and
at least one dry transfer symbol removable affixed to each of said plurality of sheets.

12. The carrier sheet of claim 11, wherein a selected number of said plurality of sheets include at least one dry transfer symbol.

13. The carrier sheet of claim 11, wherein each of said plurality of sheets further comprises polygons.

14. The carrier sheet of claim 11, wherein each of said plurality of sheets further comprises a shape selected from the group consisting of squares, rectangles, circles, triangles, trapezoids, regular polygons, irregular polygons, enclosed arced shapes, and irregular enclosed shapes.

15. The carrier sheet of claim 11, where said plurality of sheets further comprise at least two different shapes.

16. The carrier sheet of claim 11, wherein said plurality of sheets are arranged in a grid.

17. The carrier sheet of claim 11, wherein a selected number of said plurality of sheets are separable from said carrier sheet by two perforated edges.

18. The carrier sheet of claim 11, wherein a selected number of said plurality of sheets are separable from said carrier sheet by three perforated edges.

19. The carrier sheet of claim 11, wherein a selected number of said plurality of sheets are completely separable from said carrier sheet.

20. The carrier sheet of claim 11, wherein a selected number of plurality of sheets are separated by a non-detachable spacer area.

21. A book of dry transfer carrier sheets, said book comprising:
a front cover;
a rear cover affixed to said front cover;
a plurality of dry transfer carrier sheets disposed between said front and rear cover, wherein each of said plurality of dry transfer sheets includes a plurality of dry transfer symbols removably affixed to a plurality of perforated sheet units; and
at least one dry transfer symbol removably affixed to at least one side of each of said plurality of perforated sheet units.

22. A method of applying dry transfer symbols, said method comprising the steps of:
providing a carrier sheet of dry transfer symbols, said dry transfer symbols removably affixed to a plurality of perforated sheet units of said carrier sheet;
separating a first of at least one of said perforated sheet units from said carrier sheet along at least one perforated edge; and
applying said dry transfer symbol from said first perforated sheet unit to a receiving surface.

23. The method of claim 22, further comprising:
the step of separating a second of at least one of said perforated sheet units from said carrier sheet along at least one of a perforated edge; and
applying said dry transfer symbol from said second perforated sheet unit to a receiving surface.

24. The method of claim 23, further comprising:
the step of arranging said separated perforated sheet units into at least a portion of a group prior to the step of applying each of said dry transfer units to a receiving surface.
